(19) United States
(12) Patent Application Publication
(10) Pub. No.: US 2010/0171921 A1
(43) Pub. Date: Jul. 8, 2010

(54) LIQUID CRYSTAL DISPLAY

(75) Inventors: Alexei Removich Khokhlov, Moscow (RU); Alexander Vyacheslavovich Emelyanenko, Moscow (RU); Evgeny Pavlovich Pozhidaev, Moscow (RU); Nikolay Mikhailovich Shtykov, Moscow (RU); Vadim Evgenievich Molkin, Moscow (RU); Hui-Lung Kuo, Taipei City (TW); Yi-Ping Hsieh, Changhua City (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 12/349,070

(22) Filed: Jan. 6, 2009

(51) Int. Cl. G02F 1/139

(52) U.S. Cl. 349/174

(57) ABSTRACT

A liquid crystal display (LCD) includes two glass substrates, a liquid crystal unit formed by sandwiching a liquid crystal layer between the two glass substrates, a first polarizing film, and a second polarizing film. In another example, the LCD further includes a diffuse reflective film formed on the other side of the second polarizing film. In another example, the second polarizing film is replaced by a reflective film. The liquid crystal layer is composed of an antiferroelectric (including intermediate antiferroelectric) smectic liquid crystal material, and a birefringence of the liquid crystal layer changes along with an electric field applied to the liquid crystal layer.

### BACKGROUND OF THE INVENTION

1. Field of Invention

The present invention relates to a liquid crystal display (LCD), and more particularly to a color LCD without color filters and formed by using an antiferroelectric (including intermediate antiferroelectric, which is also called ferrielectric) smectic liquid crystal material.

2. Related Art

Liquid crystal displays (LCD) have advantages of thin thickness, light-weight, low power consumption, no radiation pollution, and being compatible with semiconductor process, in early stages, LCD products are applied to watches, calculators, and other display products with low information capacity, and are increasingly applied to monitors or portable information products. Recently, the LCDs are applied to LCD televisions.

The LCD is basically composed of liquid crystal molecules, which are organic compounds with a regular molecular arrangement. According to different molecular structure arrangements, the liquid crystal molecules may be classified into smectic liquid crystal, nematic liquid crystal, cholesteric liquid crystal, etc. The liquid crystal molecules not only have a characteristic of being capable of flowing under an external force owned by the liquid, but also has an optical anisotropic property owned by the crystal, so the liquid crystal arrangement state may be changed by applying an electric field. When the liquid crystal arrangement state is changed, the optical properties of light rays passing through the liquid crystal layer are changed. The light modulation is generated by applying an electric field, which is generally called liquid crystal photoelectric effect. Various LCDs may be manufactured by using the effect, such as a twisted nematic LCD, a super twisted nematic LCD, and a thin film transistor LCD.

Recently, the LCD has color filter films, also referred to as color filters, of three primary colors including red, green, and blue, and a color LCD is formed by combining the three colors, which is the main display scheme of the active matrix LCD and the passive LCD. The so-called color filter film is formed by coating a transparent color thin film on a transparent glass, and filters light when nature light passes through the transparent glass. The filter films with different colors generate color lights with different colors. Therefore, the filter film may realize a full color effect of the flat panel display.

Although the recent technical main stream of the LCD is to use the color filter, recently in some technical schemes, the color effect may be generated without using the color filter, for example, a birefringent film is adapted in the nematic LCD. These techniques have the greatest advantage of reducing the light loss ratio and saving the cost of the color filter. The birefringence color is formed by an interference effect and a dispersion effect in a liquid crystal unit, a color state of a pixel is formed because of the birefringence effect in the liquid crystal display unit, and the color state of the pixel is changed by supplying a voltage to each pixel.

### SUMMARY OF THE INVENTION

The present invention is directed to a liquid crystal display (LCD), in which a display unit is mainly composed of a smectic liquid crystal material of antiferroelectric (including intermediate antiferroelectric), so as to achieve an objective of color display without using color filters.

The LCD according to an embodiment of the present invention includes two glass substrates, a liquid crystal unit formed by sandwiching a liquid crystal layer between the two glass substrates, a first polarizing film, and a second polarizing film. In another embodiment, the LCD further includes a diffuse reflective film formed on the other side of the second polarizing film. In another embodiment, the second polarizing film is replaced by a reflective film.

In the LCD according to the embodiment of the present invention, the liquid crystal layer is composed of a smectic liquid crystal material, and a birefringence of the liquid crystal layer changes along with an electric field applied to the liquid crystal layer.

Within the temperature range, under the premise of providing the electric field, the color state of the birefringence is changed step-wise, such that the liquid crystal layer disposed between the polarizers may generate several colors without the color filters, and a time switching between the color states is approximately 10 μs. Therefore, the embodiment of the present invention is applicable to the display technique as several full-color optical states may be realized in the same material or in the mixture of materials.

### BRIEF DESCRIPTION OF THE DRAWINGS

FIG. 1 is a schematic view of an LCD according to a first embodiment of the present invention.

FIG. 2 is a schematic view of an LCD according to a second embodiment of the present invention.

FIG. 3 is a schematic view of an LCD according to a third embodiment of the present invention.

FIGS. 4A to 4F show the sequence of tilted smectic phase of smectic liquid crystal.

FIG. 5 illustrates the thresholds of the birefringence when the applied electric field on MHPBC is increased.

FIG. 6 illustrates the response time in the intermediate antiferroelectric (ferrielectric) phases.

FIG. 7 illustrates a light transmission spectrum of the liquid crystal material mixture.

### DETAILED DESCRIPTION OF THE INVENTION

In a liquid crystal display (LCD) according to an embodiment of the present invention, a display unit is mainly composed of an antiferroelectric (including intermediate antiferroelectric) smectic liquid crystal material, the state of the smectic liquid crystal material may be changed after being affected by an applied electric field, and light rays shows different colors, such that a color LCD is manufactured without color filters.

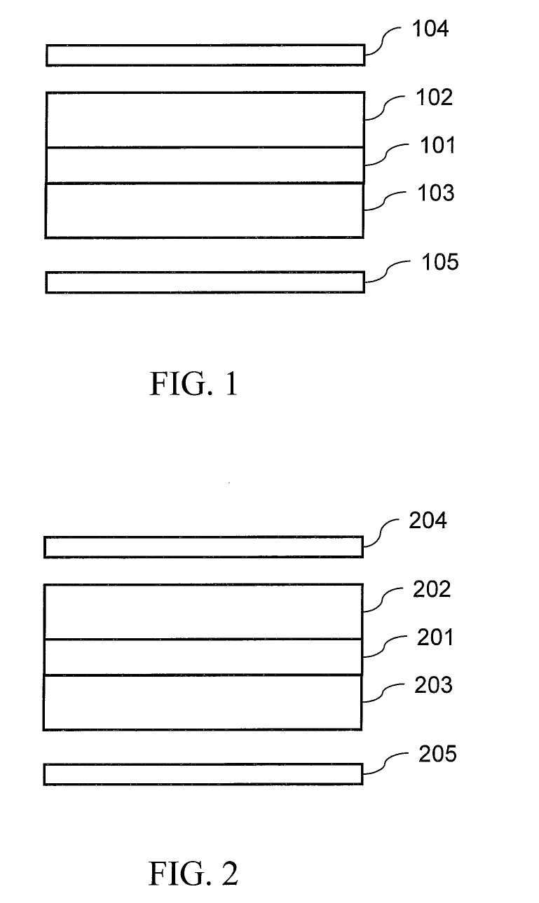

FIG. 1 is a schematic view of an LCD according to a first embodiment of the present invention. Referring to FIG. 1, in this first embodiment, the LCD includes a liquid crystal layer 101 sandwiched between an upper glass substrate 102 and a lower glass substrate 103. A conductive transparent electrode, an alignment layer, and other thin layers required to form the LCD are selectively formed on the upper glass substrate 102 and/or the lower glass substrate 103. A first polarizing film 104 is formed above the upper glass substrate 103, and a second polarizing film 105 is formed below the lower glass substrate 103. The LCD of the first embodiment may be, but not limited to, a transmissive display device.

FIG. 2 is a schematic view of an LCD according to a second embodiment of the present invention. Referring to FIG. 2, in the second embodiment, the LCD includes a liquid crystal layer 201 sandwiched between an upper glass substrate 202 and a lower glass substrate 203. A conductive transparent electrode, an alignment layer, and other thin layers required to form the LCD are selectively formed on the upper glass substrate 202 and/or the lower glass substrate 203. A polarizing film 204 is formed above the upper glass substrate 203, and a reflective film 205 is formed below the lower glass substrate 203. The reflective film 205 is a special reflector, and does not have any polarizing function. The LCD of the second embodiment may be, but not limited to, a reflective display device with a single polarizing film.

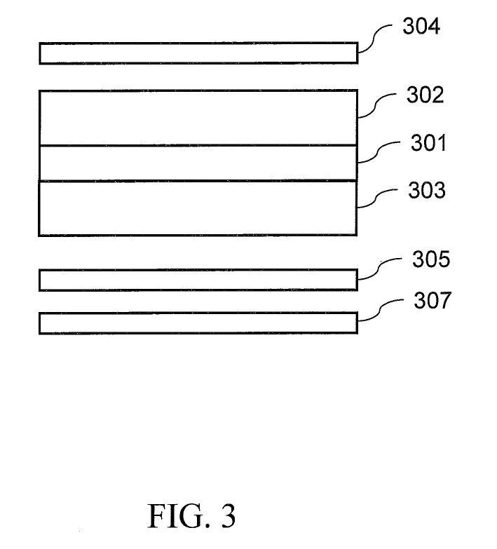

FIG. 3 is a schematic view of an LCD according to a third embodiment of the present invention. Referring to FIG. 3, in the third embodiment, the LCD includes a liquid crystal layer 301 sandwiched between an upper glass substrate 302 and a lower glass substrate 303. A conductive transparent electrode, an alignment layer, and other thin layers required to form the LCD are selectively formed on the upper glass substrate 302 and/or the lower glass substrate 303. A first polarizing film 304 is formed above the upper glass substrate 303, and a second polarizing film 305 is formed below the lower glass substrate 303. In this embodiment, the LCD further includes a diffuse reflective film 307 disposed below the second polarizing film 305. The LCD of the third embodiment may be, but not limited, to a transflective display device.

In the first to the third embodiments, the liquid crystal layer is filled with a smectic liquid crystal material. The liquid crystal molecules of the liquid crystal phase are arranged in layers, each layer has a one-dimensional layer arrangement and two-dimensional regularity, and the order degree of the molecules is increased. Under different temperatures, the used smectic liquid crystal material has antiferroelectric phases (including intermediate antiferroelectric) or a ferroelectric phase.

In the present invention, the smectic liquid crystal with antiferroelectric (including intermediate antiferroelectric) is used in the liquid crystal layer of the embodiment, and any of these liquid crystal states may be affected by the electric field to generate different states. Therefore, antiferroelectric (including intermediate antiferroelectric) smectic liquid crystal generates lights with different colors by applying different electric fields to change the birefringence.

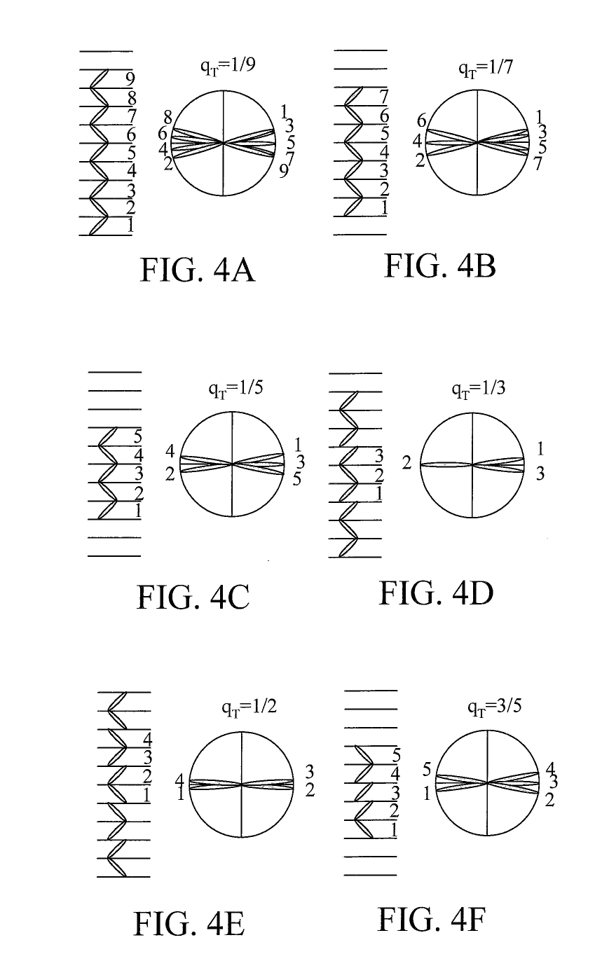

Generally, the smectic liquid crystal has a sequence of tilted smectic phases, and each layer has a different orientation distribution, as shown in FIGS. 4A to 4F. The sequence includes a Sm-C*_{A} phase, a Sm-C* phase, a Sm-A* phase, an intermediate biaxial phases between the Sm-C*_{A} phase and the Sm-C* phase, and an intermediate uniaxial Sm-C*_{α} phase between the Sm-C phase and the Sm-A* phase, in which the Sm-C*_{α} phase has the same symmetry as that of the Sm-C* phase, but has a smaller helical pitch than that of the Sm-C* phase.

It may be found from the figures that the synclinic or anticlinic arrangement is distributed according to a particular rule for each phase. Here, q_{T} is used to represent the part of synclinic arrangement in each unit, in which q_{T} is between 0 and 1, the value of q_{T} is 0 in the Sm-C*_{A} phase, and the value of q_{T} is 1 in the Sm-C* phase.

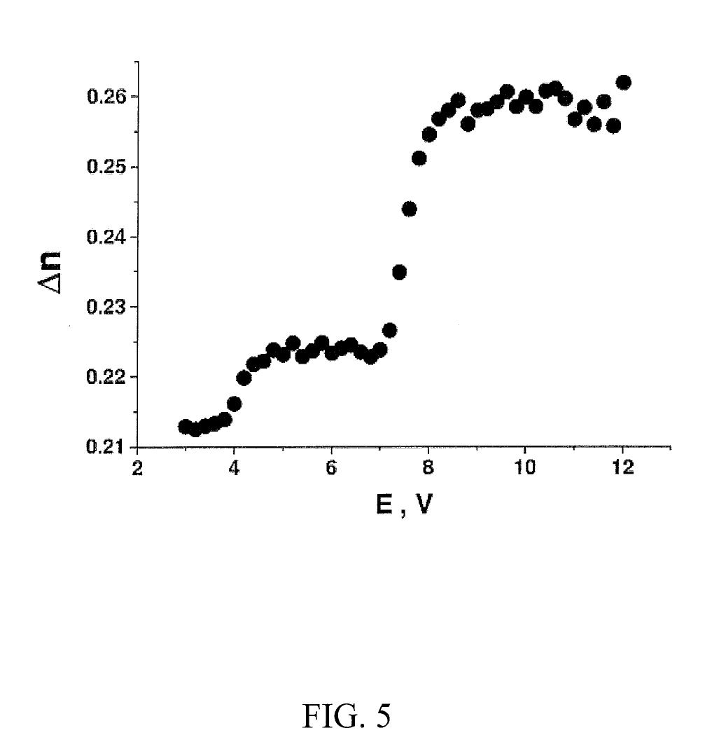

In some smectic liquid crystal materials, such as MHPBC material, as the applied electric field is increased, the birefringence may generate two thresholds as shown in FIG. 5, and the change of the birefringence may result in the change of the color. However, in FIG. 5, only the color change generated by the higher birefringence falls within the visible light range. Therefore, the different colors may be generated by applying the appropriate electric fields.

The colors of the liquid crystal layer may be changed by applying different electric fields. In an exemplary embodiment, a liquid crystal material mixture may be composed of the liquid crystal materials as shown in the following table, so as to serve as the liquid crystal layer as described in the embodiment. The chemical structure and the composition are shown in the following table.

| Chemical Structure | Wt % |
|---|---|
| 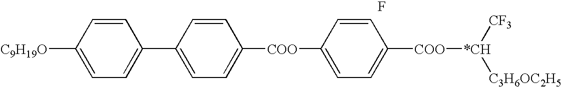 | 41.7% |
| 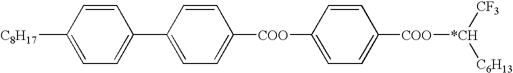 | 38.5% |
| 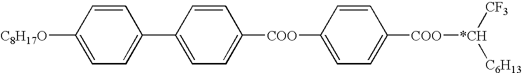 | 19.8% |

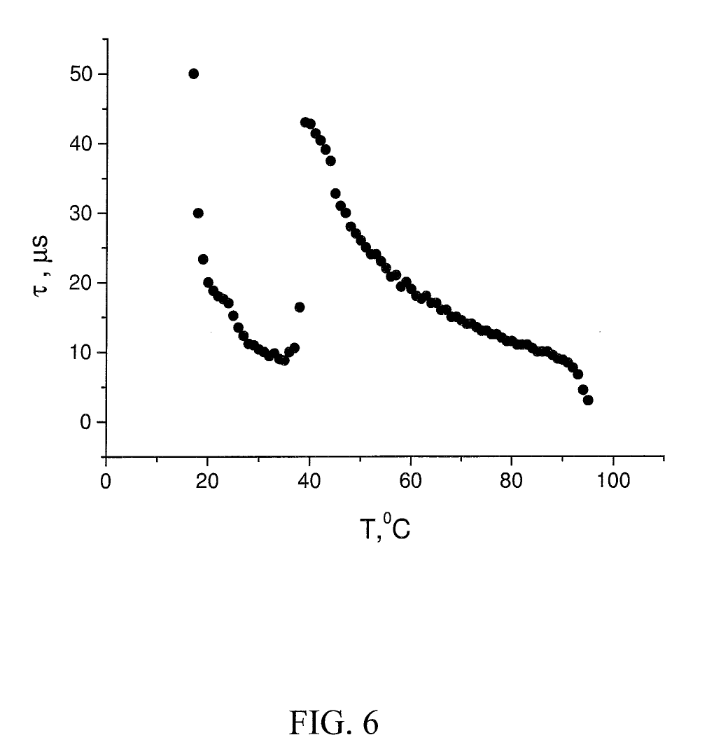

The liquid crystal material mixture in the above table has the ferroelectric phase and the antiferroelectric phases (including intermediate antiferroelectric) existing in a larger temperature range. When applying the electric field to the liquid crystal unit composed of the mixture of the materials, many birefringence color states may be observed in each pixel with a quite rapid switching speed, as shown in FIG. 5. The main reason is that the liquid crystal layer itself may generate several colors through the step-wise effect between the thresholds. As shown in FIG. 6, a response time is approximately 8 μs in the intermediate antiferroelectric phases (the temperature is approximately between 20° C. and 40° C.).

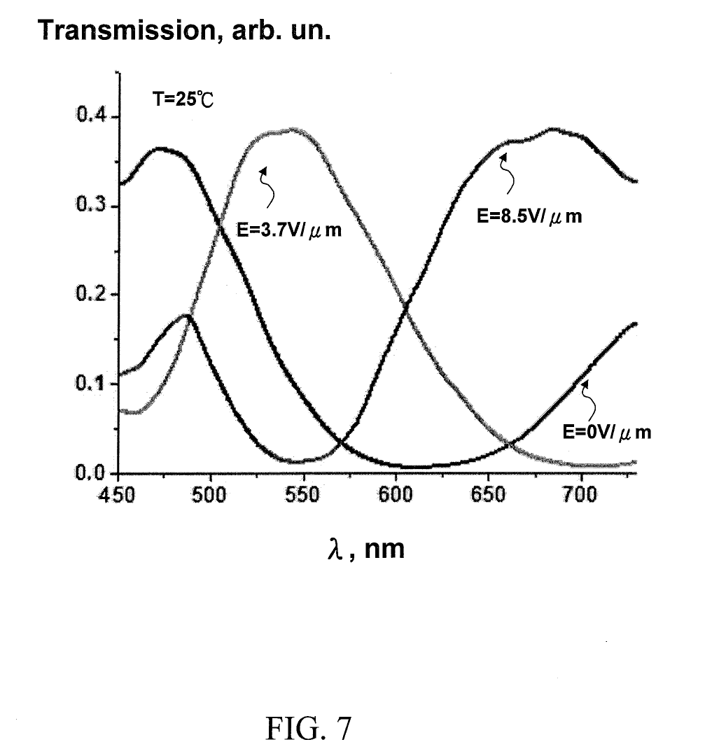

A light transmission spectrum of the liquid crystal material mixture is as shown in FIG. 7, a measured liquid crystal layer thickness is approximately from 4.5 μm to 5 μm. In one embodiment, the thickness is 4.75 μm, and the liquid crystal layer is placed between two polarizers and is measured with the Ocean Optics spectrometer. It may be found from the view that when different voltages are applied, the liquid crystal layer has different color states. It may be known from the view that when the applied voltage E is 8.5 V/μm, the liquid crystal layer assumes red. When the applied voltage E is 3.7 V/μm, the liquid crystal layer assumes green. When the applied voltage E is 0 V/μm, the liquid crystal layer assumes blue. That is, as the applied voltage is increased, the color is changed from blue to green, and then from green to red. Therefore, when the different voltages are applied, it may be known from the measuring result of FIG. 7 that the three primary colors of blue, red, and green may be obtained. Therefore, in the present invention, the color effect may be generated indeed by applying the electric field without using any color filters.

The LCD of the present invention does not adopt the color filters, thus having a low cost as compared with the existing LCD. Therefore, it may be applied to some electronic devices with low cost, such as game players, electronic watches, and mobile phones.

What is claimed is:

1. A liquid crystal display (LCD), comprising:
two glass substrates;
a liquid crystal layer, sandwiched between the two glass substrates, and composed of an antiferroelectric (including intermediate antiferroelectric) smectic liquid crystal material;
a first polarizing film, formed on one side of one of the two glass substrates; and
a second polarizing film, formed on one side of the other of the two glass substrates;
wherein a birefringence of the liquid crystal layer changes along with an electric field applied to the liquid crystal layer.

2. The LCD according to claim 1, wherein a thickness of the liquid crystal layer is approximately from 4.5 μm to 5 μm.

3. The LCD according to claim 1, wherein a color of the liquid crystal layer is changed in a sequence of blue, green, and red with the increase of the applied electric field.

4. The LCD according to claim 1, further comprising a diffuse reflective film formed on the other side of the second polarizing film.

5. The LCD according to claim 4, wherein a thickness of the liquid crystal layer is approximately from 4.5 μm to 5 μm.

6. The LCD according to claim 4, wherein a color of the liquid crystal layer is changed in a sequence of blue, green, and red with the increase of the applied electric field.

7. A liquid crystal display (LCD), comprising:
two glass substrates;
a liquid crystal layer, sandwiched between the two glass substrates, and composed of an antiferroelectric (including intermediate antiferroelectric) smectic liquid crystal material;
a polarizing film, formed on one side of one of the two glass substrates; and
a reflective film, formed on one side of the other of the two glass substrates;
wherein a birefringence of the liquid crystal layer changes along with an electric field applied to the liquid crystal layer.

8. The LCD according to claim 7, wherein a thickness of the liquid crystal layer is approximately from 4.5 μm to 5 μm.

9. The LCD according to claim 7, wherein a color of the liquid crystal layer is changed in a sequence of blue, green, and red with the increase of the applied electric field.

10. The LCD according to claim 7, further comprising a diffuse reflective film.
